(19) United States
(12) Patent Application Publication
(10) Pub. No.: US 2005/0235919 A1
(43) Pub. Date: Oct. 27, 2005

(54) Pet mat

(75) Inventors: Jonathan Willinger, Tenafly, NJ (US); Ryan Rutherford, Rutherford, NJ (US)

Correspondence Address: KATTEN MUCHIN ROSENMAN LLP, 575 MADISON AVENUE, NEW YORK, NY, 10022-2585, US

(73) Assignee: JW PET COMPANY, INC.

(21) Appl. No.: 11/171,029

(22) Filed: Jun. 30, 2005

Related U.S. Application Data
(63) Continuation-in-part of application No. 10/824,199, filed on Apr. 14, 2004.
(60) Provisional application No. 60/462,757, filed on Apr. 14, 2003.

(51) Int. Cl. A01K 5/01

(52) U.S. Cl. 119/61.5

(57) ABSTRACT

A pet mat is provided with an upper surface having a pattern of raised bumps, the configurations spacing of which is such that a common pet bowl can be placed on any part of the surface and the bowl normally falls within the interstices between the pattern of the bumps. The pet mat is also provided with an overmolding having a plurality of feet. The plurality of feet are arranged such to keep the pet mat raised from the floor and are made of a material that prevents movement of the pet mat relative to the floor.

This application is a continuation-in-part application claiming the benefit of U.S. Ser. No. 10/824,199 filed on Apr. 14, 2004, which is hereby incorporated by reference in its entirety and which claims the benefit of provisional application 60/462,757 filed on Apr. 14, 2003, now abandoned.

### FIELD OF THE INVENTION

The present invention relates to mats in general, and more particularly to a pet mat that is configured to prevent and/or restrain an object, such as a food or water bowl, from moving and/or sliding around the top surface of the mat and is configured to raise the mat from the floor and prevent and/or restrain it from moving and/or sliding on the floor.

### BACKGROUND OF THE INVENTION

It is known art to place a dog mat under a feeding or water bowl. The mat serves a number of functions. It keeps the bowl from having direct contact with the floor, thereby preventing marking on the floor. Some mats also have sides to prevent spills from spreading from the bowl onto the floor of the pet owner's kitchen or other room.

However, existing mats have a major limitation. The bowl tends to slide around the top of the mat, which is generally a flat piece of plastic only interrupted by an occasional decorative rib with the logo or other decorative configuration on the top of said mat. Some mats also have dedicated bowl locations that prevent or inhibit varied bowl placement on the mat, thereby reducing the utility of the mat.

A significant limitation is that mats known in the art slide relative to the floor. Thus, when a pet aggressively consumes food or water it pushes against its bowl causing the bowl to slide off the mat. When the mat has features such as bumps that prevent sliding of the bowl relative to the mat, it may cause the mat itself to slide on the floor. Thus, the food or water in the bowl may spill over the rim of the bowl or the bowl itself may tip over as the mat is being moved. A situation more dire occurs when the mat in its unwilling journey suddenly encounters an obstacle, such as a wall. In that case, it is likely that the contents of the bowl are deposited on the floor necessitating a clean-up of the mess by the pet's owner.

Furthermore pet mats known in the art suffer from the drawback of having the underside of the mat surface rest directly on the floor. This results in many unintended consequences. For example, a mat resting with its underside on a floor tends to wobble on certain types of flooring material, such as tiled floors, because of the imperfections and unevenness in the placement of the tiles. Thus, the mat may rock back and forth as the animal eats and on causing food or water to spill. Another unintended consequence is that temperature transfer from the floor to the food in the bowl causes the room-temperature food to become unsuitably cooled by a winter floor. Further, a pet mat that is raised from the floor brings food closer to the natural eating height of pets, thus, making it easier for the pet to feed. Conversely, a pet mat surface that rests on the floor makes it harder to feed for the pet.

In case of a spill onto a floor, a pet mat that has an underside resting on the floor may trap the spill on its underside. Thus, as the mat is removed from the floor for clean-up water or food clings to the underside tracking the spillage further.

Thus, what is need is a pet food mat that is resistant to unintended movement of the bowl relative to the mat on which the bowl rests and that is resistant to movement of the mat relative to the floor on which the mat rests.

What is needed also is a pet mat that is raised from floor to provide mat surface that is further removed from the floor reducing the aforementioned limitations and drawbacks.

### SUMMARY OF THE INVENTION

The mat of the present invention overcomes the deficiencies of prior art mats through the use of a pattern of raised bumps. The configuration and spacing of said bumps is such that a common pet bowl or dish can be placed on any part of the top surface of the mat and the bowl will normally fall within the interstices between the pattern of bumps. In said manner, the bowl does not slide or slip around the mat. This helps prevent spillage on the mat itself so that in combination with the sides of the mat, the chance of spillage off of the mat onto the floor itself is greatly reduced. The mat is preferably formed from a tacky material, such a natural rubber, which further aids in the goal of reducing slippage. Such tacky material helps prevent and/or restrain both bowl slippage on the bowl-receiving surface of the mat as well as slippage of the mat itself on the floor.

The mat of the present invention also overcomes the deficiency of prior art mats through the use of an overmolding that intergrades a plurality of feet made of tacky material. If preventing the sliding of the mat relative to the floor.

### BRIEF DESCRIPTION OF THE DRAWINGS

FIG. 1 is a top view of an embodiment of the pet mat of the present invention.

FIG. 2A is a cross-sectional view taken through line 2A-2A in FIG. 1.

FIG. 2B is a close-up view of section 2B in FIG. 2A.

FIG. 3A is a cross-sectional view taken through line 3A-3A in FIG. 1.

FIG. 3B is a close-up view of section 3B in FIG. 3A.

FIGS. 4-7 illustrate potential bowl placement on the pet mat of FIG. 1.

FIG. 8 is a planar view of a second embodiment of the pet mat of the present invention.

FIG. 9 is a cross-sectional view of the second embodiment of the pet mat of the present invention.

FIG. 10 is an elevational view of the second embodiment of the pet mat of the present invention.

### DETAILED DESCRIPTION OF THE PREFERRED EMBODIMENTS

The following detailed description is of the best mode or modes of the invention presently contemplated. Such description is not intended to be understood in a limiting sense, but to be an example of the invention presented solely for illustration thereof, and by reference to which in connection with the following description and the accompanying drawings one skilled in the art may be advised of the advantages and construction of the invention. In the various views of the drawings, like reference characters designate like or similar parts.

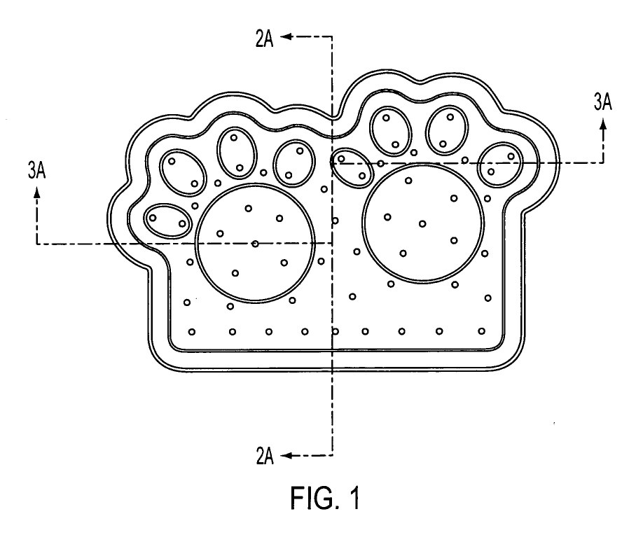

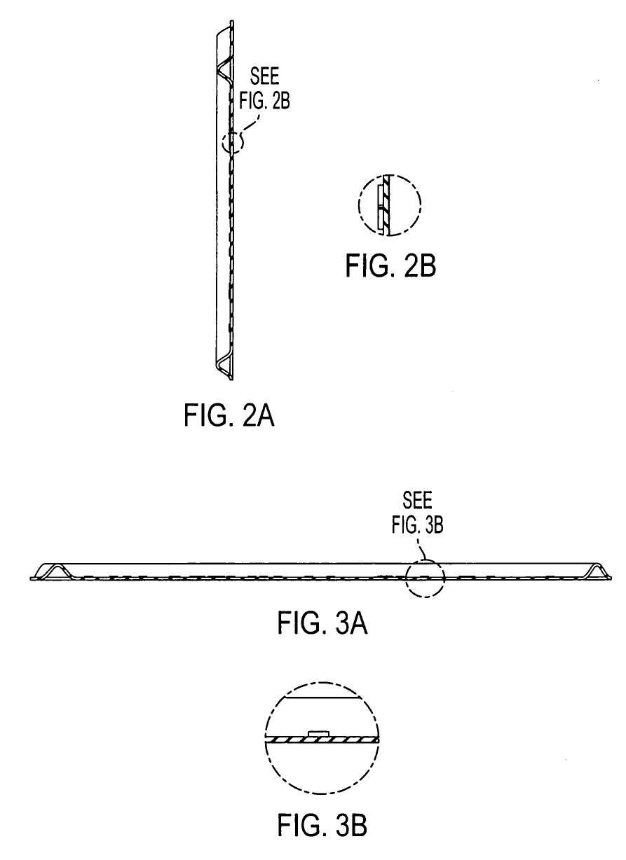

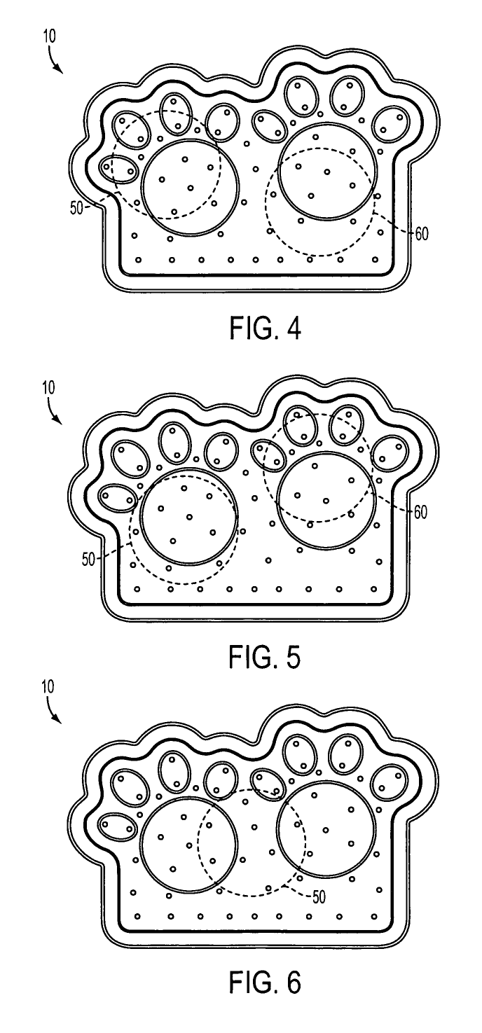

FIG. 1 illustrates a pet mat 10 of the present invention comprising an upper surface 20 bounded by a raised peripheral edge 30 and a plurality of raised bumps 40 arranged on said upper surface 20 in an irregular, asymmetric pattern. The bumps 40 are spaced such that a bowl 50 (see FIGS. 4-7) placed on said upper surface 20 is restrained by said bumps 40 in a plurality of non-dedicated locations. In other words, a bowl 50 or a plurality of bowls 50, 60 do not have to be placed in only one or two locations on the upper surface 20, but can be placed in many different locations as long as the bowl rims are situated within the interstices between the bumps 40. A series of bumps are spaced from the raised peripheral edge 30 to prevent and/or restrain a bowl placed on said upper surface 20 from moving toward or near said raised peripheral edge 30. Of course, while there is no danger if a pet bowl contacts the raised peripheral edge 30, the peripheral series of bumps serves to keep a pet bowl farther away from the edge of the mat 10, which may help contain food and/or water spillage within the confines of the upper surface 20 if the pet is a messy eater.

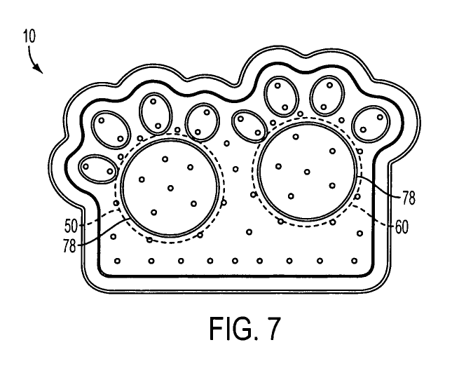

The raised peripheral edge 30 of the illustrated embodiment preferably has an irregular shape that is best seen from the top view of FIG. 1. For example, at least one portion 32 of the edge 30 is curved, while another portion 34 is straight or not curved. This illustrates a departure from the conventional pet mat having a raised peripheral edge, which is usually bowl-shaped or of another standard geometric configuration. In addition, the curved portion 32 approximately traces at least one aspect of a decorative image 70 embossed or imprinted on the upper surface 20 of the mat 10. In the illustrated embodiment, such image 70 is a pair of paw prints 72, 74 (although other ornamental designs are contemplated) comprising a plurality of oval digit locations 76, each digit outline 76 containing within a pair of bumps 40. The “palm” portion 78 of each paw print is preferably circular and may function as a location guide for a pet bowl (see FIG. 7). However, as shown in FIGS. 4-6, a pet bowl may be placed anywhere on the mat and not only within the “palm” portions 74.

The pet mat 10 of the present embodiment is preferably formed from a non-stick, tacky material, such as natural rubber. Other non-stick, tacky materials are contemplated. Such material prevents or inhibits a pet bowl from sliding or slipping around the mat 10 and helps prevent spillage on the upper surface 20 of the mat 10 so that, in combination with the raised peripheral edge 30, the chance of spillage off of the mat 10 onto a floor is greatly reduced. A tacky material also helps prevent slippage of the mat 10 itself on the floor.

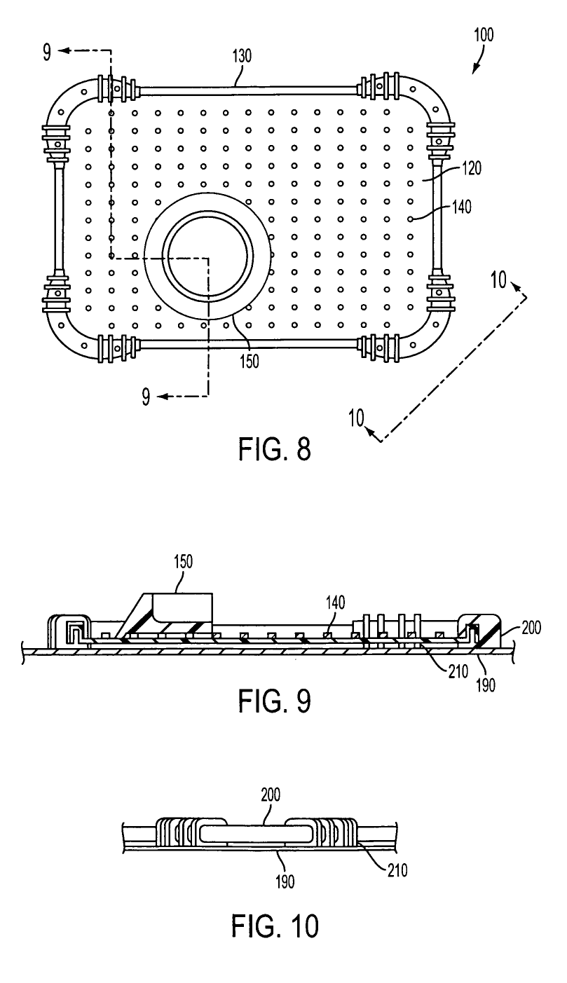

FIG. 8 is a planar view of pet mat 100. Therein, pet mat 100 has a substantially rectangular shape that maximizes the surface area, but also for safety has overmolded rounded corners that form an attractive and interesting shape. An upper surface 120 of the pet mat is bounded on all sides by a raised peripheral edge 130. A series of regular or irregularly and asymmetrically spaced bumps 140 are disposed on the upper surface 120 to restrain one or more bowls 150 that provide food and/or water for a pet from sliding on pet mat 100.

The arrangement of bumps 140 permits bowl 150 to be placed anywhere that is suitable (see FIGS. 4-7). Preferably, the bottom rim of bowl 150 is located at the interstices of bumps 140. Bumps 140 are also preferably spaced from raise peripheral edge 130 to prevent a bowl from moving toward or near raised peripheral edge 130. Raised peripheral edge 130 is suitable sized to contain a spill of food and/or water from bowl 150 from leaving the mat.

FIG. 9 is a cross-sectional view of pet mat. Therein, pet mat 100 further comprises an overmolding 200 having a plurality of spaced apart feet 210 that space pet mat 100 from floor 190 a desirable distance. Thus, pet mat 100 may be spaced from the floor to prevent thermal transfer that undesirably cools the food or water, allows for easier spill clean-up, a more stable surface for a pet feeding bowl.

While pet mat 100 may be formed from a non-porous, non-stick material such as plastic, the overmolding 200 is preferably formed from a tacky natural rubber or manmade rubber material or an elastomeric material that is suitably thermally sensitive to permit molding. The material of the overmolding is continued in and/or other suitable material is provided for feet 210 to provide a frictional resistance and also act to absorb impact for pet mat 100, thusly, aiding pet mat 100 from moving or sliding relative to floor 190. The combination of bumps 140 and feet 210 to prevent and/or restrain moving and/or sliding of the bowl relative to the pet mat and prevent and/or restrain movement and/or sliding of the pet mat relative to the floor preventing spillage of the contents of the bowl.

FIG. 10 is an elevational view of pet mat 100 in accordance with one or more embodiments of the present invention. Therein, overmolding 200 is in contact with upper surface 120 and an underside of pet mat 100 and has a suitable thickness to allow a user to grasp and raise the pet mat at the overmolding. Overmolding 200 is placed so that the entire cross-sectional area or at least a portion of the cross-sectional area of raised peripheral edge 130 is overmolded (see FIG. 9).

Each overmolding 200 is preferably placed at a corner of pet mat 100 and may comprise one or more spaced apart feet 210 that are preferably placed in pairs so that at least one pair is parallel to the longitudinal axis of the pet mat while at least one other pair is placed parallel to the transverse axis of the pet mat. Thus, pet mat 100 has resistance to moving and/or sliding not only in the longitudinal and/or transverse direction but also in the entire plane of the floor.

Returning to FIG. 8, when an animal aggressively feeds and bumps against bowl 150, corresponding bumps 140 restrain the bowl from moving. In essence, the pet's force is transferred from the bowl to the bumps and the upper surface. Without the resistance of feet 210 against floor 190, the pet mat would move. Instead feet 210 being made of suitable material that offers frictional and impact resistance absorb the impact forces and prevent moving and/or sliding of the pet mat relative to the floor.

To accentuate the moving and/or sliding resistance, spaced apart feet 210 preferably have a rectangular shape that without undue waste of material is substantially longer than wider in the direction the feet offer resistance. For example, the feet parallel to the longitudinal axis are substantially longer in the longitudinal axis than they are wider in the pet mat's transverse direction. Similarly, the feet parallel to the transverse axis are substantially longer in the transverse axis than they are wider in the pet mat's longitudinal direction. It should, of course, be appreciated that feet 210 may be shaped differently or be placed on any convenient axis.

In one embodiment, feet 210 extend along the outside perimeter of the overmolding and reinforce the overmolding for stability. In a further embodiment, feet 210 are themselves reinforced with a rigid material.

While overmolding 200 may be placed economically only at the corners, it may also be placed entirely along the peripheral edge 130 to prevent a user from noticing peripheral edge 130. Therein, it may be advantageous to have the overmolding include a continuous support for the pet mat from the floor rather than spaced apart feet 210.

The pet mat of the present invention may be usefully manufactured by obtaining a surface having a peripheral edge and a plurality of bumps. The pet mat in a region of the edge is then overmolded, preferably in a corner, with a suitable material, such as an elastomeric material. The feet or support are the formed preferable in the overmolding.

While the present invention has been described at some length and with some particularity with respect to the several described embodiments, it is not intended that it should be limited to any such particulars or embodiments or any particular embodiment, but it is to be construed with references to the appended claims so as to provide the broadest possible interpretation of such claims in view of the prior art and, therefore, to effectively encompass the intended scope of the invention. Furthermore, the foregoing describes the invention in terms of embodiments foreseen by the inventor for which an enabling description was available, notwithstanding that insubstantial modifications of the invention, not presently foreseen, may nonetheless represent equivalents thereto.

1. A pet mat comprising:
a surface for supporting a bowl for nourishing a pet;
a raised edge disposed on the periphery of the surface to contain a spill from the bowl;
a plurality of raised bumps disposed on the upper surface, the plurality of bumps resisting movement of the bowl relative to the upper surface;
a plurality of feet supporting the surface, the plurality of feet resisting movement of the pet mat relative to a floor on which the pet mast rests.

2. The pet mat of claim I having a longitudinal axis and a transverse axis in the plane of the surface, wherein a first plurality of feet of the plurality of feet is disposed parallel to the longitudinal axis of the pet mat and a second plurality of feet of the plurality of feet is disposed parallel to the transverse axis of the pet mat.

3. The pet mat of claim 1 further comprising an overmolding placed over the raised peripheral edge.

4. The pet mat of claim 3 wherein the overmolding is placed at a corner of the pet mat.

5. The pet mat of claim 3 wherein the overmolding comprises at least one foot of the plurality of feet.

6. The pet mat of claim 3 wherein the overmolding comprise an elastomeric material.

7. The pet mat of claim 1 wherein the plurality of feet comprise an elastomeric material.

8. A pet mat comprising:
a support surface for a container;
a first restraint for resisting movement of the container relative the support surface; and
a second restraint for resisting movement of the support surface relative to a floor on which the pet mat rests.

9. The pet mat of claim 8, wherein the second restraint comprises a plurality of feet.

10. The pet mat of claim 9, wherein the pet mat has a longitudinal axis and a transverse axis in the plane of the support surface, wherein a first plurality of feet of the plurality of feet is disposed parallel to the longitudinal axis of the pet mat and a second plurality of feet of the plurality of feet is disposed parallel to the transverse axis of the pet mat.

11. The pet mat of claim 8, wherein the first restraint comprises a plurality of bumps.

12. The pet mat of claim 8, wherein the support surface comprises a raised edge at the periphery of the support surface for containing a spill from the container.

13. The pet mat of claim 7 further comprising an overmolding.

14. The pet mat of claim 13, wherein the overmolding comprises at least one foot of the plurality of feet.

15. The pet mat of claim 13 wherein the overmolding comprises an elastomeric material.

16. The pet mat of claim 8 wherein the second restraint comprises an elastomeric material.

17. A method of making a pet mat, the method comprising:
providing a surface for supporting a bowl for nourishing a pet; the surface comprising a raised edge disposed on a periphery of the surface to contain a spill from the bowl and a plurality of raised bumps disposed on the upper surface, the plurality of bumps resisting movement of the bowl relative to the upper surface; overmolding a corner of the pet mat; and
forming a plurality of feet for supporting the surface, the plurality of feet resisting movement of the of the pet mat relative to a floor on which the pet mast rests.

18. The method of making the pet mat of claim 17, wherein the plurality of feet are formed

19. The method of making the pet mat of claim 17, wherein the plurality of feet are formed in the overmolding.

20. The method of making the pet mat of claim 17, wherein the step of forming a plurality of feet is performed with an elastomeric material.

21. The method of making the pet mat of claim 17, wherein the step of overmolding a corner is performed with an elastomeric material.
